(19) United States
(12) Patent Application Publication
(10) Pub. No.: US 2015/0201030 A1
(43) Pub. Date: Jul. 16, 2015

(54) SYSTEMS AND METHODS FOR PROVIDING GEOGRAPHICALLY DELINEATED CONTENT

(71) Applicant: CO EVERYWHERE, INC., Boston, MA (US)

(72) Inventors: Anthony Longo, Boston, MA (US); Daniel Alan Adams, Melrose, MA (US)

(21) Appl. No.: 14/572,270

(22) Filed: Dec. 16, 2014

Related U.S. Application Data
(60) Provisional application No. 61/963,849, filed on Dec. 16, 2013.
(60) Provisional application No. 61/963,850, filed on Dec. 16, 2013.
(60) Provisional application No. 61/995,015, filed on Apr. 1, 2014.

(51) Int. Cl. H04L 29/08; G06F 17/30

(52) U.S. Cl. CPC H04L 67/22; H04L 67/18; G06F 17/30864

(57) ABSTRACT

Systems and methods are provided that provide geographically delineated content. In one implementation, a system comprises an interface configured to receive, from a user device, a user input identifying a geographic location, a location-based service including a distributed computer system having at least one processor in data communication with the interface, a delineation component executable by the at least one processor and configured to query at least one social media content provider and aggregate geographically delineated content generated by one or more user, the content being received from the at least one social media content provider responsive to the received user input, and a relation component executable by the at least one processor and configured to determine a heatmap visualization from the aggregated geographically delineated content.

### RELATED APPLICATIONS

This application claims priority under 35 U.S.C. 119(e) to U.S. Provisional Patent Application Ser. No. 61/963,849 entitled “Methods of Geographic Delineation,” filed on Dec. 16, 2013, which application is herein incorporated by reference in its entirety. This application also claims priority under 35 U.S.C. 119(e) to U.S. Provisional Patent Application Ser. No. 61/963,850 entitled “Content Provision by Geographic Delineation,” filed on Dec. 16, 2013, which application is herein incorporated by reference in its entirety. This application further claims priority under 35 U.S.C. 119(e) to U.S. Provisional Patent Application Ser. No. 61/995,015 entitled “Methods of Geographic Delineation,” filed on Apr. 1, 2014, which application is herein incorporated by reference in its entirety.

### BACKGROUND

There are many companies that provide, consume, and transfer social networking information via the Internet, such as Twitter, Facebook, MySpace, LinkedIn, Pinterest, Foursquare, Yelp, Tripadvisor and Tumblr. Social networking sites allow individuals to access social media content related to business and commerce, as well as personal needs and desires. Content often includes text, photographs, videos, and audio files. In particular, some social media content providers provide location-based services permitting a user to attach a location to generated content. For example, within one type of location-based social network, users are permitted to perform a “check-in” to particular locations, including venues such as businesses, retail locations, events, points of interest, or other locations. A check-in generally includes a process that identifies the user with a particular location at a given time, and may be recorded over time. Accordingly, location-based social networks permit users to find venues of interest, find content of interest, interact with friends, and leave comments regarding particular locations, among other functions.

### SUMMARY

Conventional location-based social media content providers connect users with a variety of artificial criteria that do not permit the exchange of relevant information in real-time communication. It is appreciated that there is a need in the industry to differentiate, or filter, social networking information (e.g., social media content or any content produced by a human otherwise known as “UGC” or user generated content), and other information based on parameters that are user determined, such as geographic location and/or content type. These and other shortcomings of the prior art are addressed in the present invention by providing systems and methods for providing geographically delineated content. In one aspect of the invention, it is desired that a service be provided that provides geographically delineated content based on a user or client generated input defining a geographic location. Further, such an application may be capable of gathering geographically delineated content generated within the defined location and determining a subset of the gathered content is relevant to the user or client. Also, in other embodiments, the service may be capable of determining a heatmap visualization from the gathered geographically delineated content, which indicates the volume of content generated at discrete locations within the defined geographic location associated with the user, or client, request.

Although associating user generated social media content with a geographic location is known, it would be beneficial to aggregate and filter location based social media content from a plurality of providers and by a plurality of multi-dimensional filters that include artificial intelligence, machine learning and natural language processing to enhance the presentation of the content. Furthermore, aggregation and analysis permits accurate predictions based on historic and trend-based comparisons. It is appreciated that the user, or client, benefits by having real-time access to more relevant social media content across multiple social content provider platforms. Additionally, heatmap visualizations facilitate automatically tailored aggregations of aggregated geographically delineated content. Accordingly, the systems and methods described herein facilitate organization and analysis of geographically delineated content.

At least one aspect of the invention is directed to a computer system comprising an interface configured to receive, from a user device, a user input identifying a geographic location, a location-based service including a distributed computer system having at least one processor in data communication with the interface, a delineation component executable by the at least one processor and configured to query at least one social media content provider and aggregate geographically delineated content generated by one or more user, the content being received from the at least one social media content provider responsive to the received user input, and a relation component executable by the at least one processor and configured to determine a heatmap visualization from the aggregated geographically delineated content.

According to one embodiment, the heatmap visualization is defined by a volume of the geographically delineated content. In one embodiment, the user input further includes one or more query parameters. In one embodiment, the geographically delineated content includes at least social media content. In one embodiment, the system further comprises a communication component configured distribute to one or more user devices the aggregated geographically delineated content.

In accordance with one embodiment, the heatmap visualization includes an image of the geographic location and a neighboring area geographically proximate the geographic location. In one embodiment, image includes at least one of, a street map, a satellite image, a mass transit map, and a schematic illustration of a detectable activity. In another embodiment, the user device further includes a device interface configured to display the heatmap visualization. In one embodiment, the heatmap visualization includes a plurality of indicators disposed on the image, the plurality of indicators indicate the volume of the geographically delineated content. In another embodiment, the device interface is further configured to display the geographically delineated content in response to activation of one of the plurality of indicators disposed on the image.

According to one embodiment, the relation component is further configured to automatically amend the user input responsive to at least the heatmap visualization. In one embodiment, the relation component is further configured to determine metrics of the aggregated geographically delineated content, compare the metrics of the geographically delineated content to metrics of geographically delineated content of the neighboring area geographically proximate the geographic location, and amend the user input responsive to the comparison. In one embodiment, the metrics include at least one of geographically delineated content provider, post source volume, content type, hashtags, @mentions, geographic location, and computer vision meta data.

In accordance with another embodiment, the relation component is further configured to determine a trend in the aggregated geographically delineated content, compare the trend to the geographically delineated content of the neighboring area geographically proximate the geographic location, and amend the user input responsive to the comparison.

In one embodiment, the system further comprises a content database configured to store the aggregated geographically delineated content. In another embodiment, the relation component is further configured to filter the aggregated geographically delineated content responsive to activation of a filter. In one embodiment, the filter includes one of geographic location shape, time period, content source, content type, hashtags, image content computer vision topic, keywords, @mentions, venue, user age, user sex, use topic interest, user domicile, and user influence level.

In accordance with one aspect of the invention, provided is a computer system comprising an interface configured to receive, from a client, an input identifying a geographic location a location-based service including a distributed computer system having at least one processor in data communication with the interface a delineation component executable by the at least one processor and configured to query at least one social media content provider and aggregate geographically delineated content generated by one or more user, the content being received from the at least one social media content provider responsive to the received input, and a relation component executable by the at least one processor and configured to determine a heatmap visualization from the aggregated geographically delineated content.

In one embodiment, the heatmap visualization is defined by a volume of the geographically delineated content. In one embodiment, the input further includes one or more query parameters. In one embodiment, the geographically delineated content includes at least social media content. In one embodiment, the system further comprises a communication component configured distribute to one or more clients the aggregated geographically delineated content. In one embodiment, the heatmap visualization includes an image of the geographic location and a neighboring area geographically proximate the geographic location. In another embodiment, the image includes at least one of, a street map, a satellite image, a mass transit map, and a schematic illustration of a detectable activity. In another embodiment, the heatmap visualization includes a plurality of indicators disposed on the image, wherein the plurality of indicators indicate the volume of the geographically delineated content.

In accordance with another embodiment, the relation component is further configured to automatically amend the input responsive to at least the heatmap visualization. In one embodiment, the relation component is further configured to determine metrics of the aggregated geographically delineated content, compare the metrics of the geographically delineated content to metrics of geographically delineated content of the neighboring area geographically proximate the geographic location, and amend the input responsive to the comparison. In one embodiment, the metrics include at least one of geographically delineated content provider, post source volume, content type, hashtags, @mentions, geographic location, and computer vision meta data.

In accordance with another embodiment, the relation component is further configured to determine a trend in the aggregated geographically delineated content, compare the trend to the geographically delineated content of the neighboring area geographically proximate the geographic location, and amend the input responsive to the comparison. In another embodiment, the system further comprises a content database configured to store the aggregated geographically delineated content. In another embodiment, the relation component is further configured to filter the aggregated geographically delineated content responsive to activation of a filter. In one embodiment, the filter includes one of geographic location shape, time period, content source, content type, hashtags, keywords, @mentions, venue, user age, user sex, use topic interest, user domicile, and user influence level.

According to another aspect of the invention, provided is a computer-executed method comprising acts of receiving an input identifying a geographic location, querying at least one social media content provider responsive to the received input, aggregating geographically delineated content from the at least one social media provider, the geographically delineated content being received from the at least one social media content provider, and determining a heatmap visualization from the aggregated geographically delineated content.

In one embodiment, receiving an input identifying a geographic location further comprises receiving an input from one or more user devices. In another embodiment, receiving an input identifying a geographic location further comprises receiving an input from one or more client devices. In one embodiment, the method further comprises an act of defining the heatmap visualization by a volume of the geographically delineated content.

In one embodiment, receiving an input further includes an act of receiving query parameters. In one embodiment, method further comprises an act of distributing the aggregated geographically delineated content.

In accordance with another embodiment, the method further comprises an act of displaying the heatmap visualization, wherein the heatmap visualization includes an image of the geographic location and a neighboring area geographically proximate the geographic location. In another embodiment, the act of displaying the heatmap visualization includes an act of displaying at least one of, a street map, a satellite image, a mass transit map, and a schematic illustration of a detectable activity. In one embodiment, the act of displaying the heatmap visualization includes an act of displaying a plurality of indicators disposed on the image, wherein the plurality of indicators indicate the volume of the geographically delineated content. In another embodiment, the method further comprises an act of displaying the geographically delineated content in response to activation of one of the plurality of indicators disposed on the image of the geographic location.

In another embodiment, the method further comprises an act of automatically amending the input responsive to at least determining the heatmap visualization. In another embodiment, amending the input includes acts of determining metrics of the aggregated geographically delineated content, comparing the metrics of the geographically delineated content to metrics of geographically delineated content of the neighboring area geographically proximate the geographic location, and amending the input responsive to the comparison. In one embodiment, the act of determining metrics of the aggregated geographically delineated content includes an act of determining at least one of geographically delineated content source, post source volume, content type, hashtags, @mentions, geographic location, and computer vision meta data.

In one embodiment, amending the input further includes acts of determining a trend in the geographically delineated content, comparing the trend to the geographically delineated content of the neighboring area geographically proximate the geographic location associated with the user input, and amending the input based on the comparison. In one embodiment, the method further comprises an act of storing the geographically delineated content. In one embodiment, the method further comprises an act of filtering the aggregated geographically delineated content.

In accordance with another aspect of the invention, provided is a method executed on a computing device for generating delineated geographic content on a touch display of the computing device, the method comprising: i) detecting at a processor on the computing device an initialization of creation of content, initialized by a first input event comprising a touch input on the touch display of the computing device through an application on the computing device, and ii) detecting at the processor a finalization of creation of content, finalized by a second input event comprising the cessation of the touch input on the touch display, wherein the created content comprises delineated geographic content.

In one embodiment, the computing device generates a visual geographic representation, such that the creation of content contains at least a subset of the visual geographic representation. In one embodiment, the visual geographic representation comprises a street map. In another embodiment the visual geographic representation comprises a satellite image. In another embodiment the visual geographic representation comprises a mass transit map. In another embodiment, the visual geographic representation comprises an image of at least one geographic location. In another embodiment, the visual geographic representation comprises a schematic illustration of a detectable activity.

In one embodiment, the detectable activity comprises traffic on a website or mobile application. In one embodiment, the first touch input comprises a user touching the touch display. In another embodiment, the touch input comprises a user touching the touch display with a single finger. In another embodiment, the touch input comprises a user contacting the touch display with a compatible article. In one embodiment, the delineated geographic content comprises a two dimensional space.

In accordance with another aspect of the invention, provided is a method executed on a computing device for generating delineated geographic content on a touch display of the computing device, the method comprising: i) detecting at a processor on the computing device an initialization of creation of content, initialized by a first input event comprising a touch input on the touch display through an application on the computing device, wherein the application is associated with geographical information viewable on or through the touch display, and ii) detecting at the processor a finalization of creation of content, finalized by a second input event comprising the cessation of the touch input on the touch display, wherein the created content comprises delineated geographic content associated with social networking information.

In one embodiment, the method further comprises displaying the social networking information on or through the touch display. In another embodiment, the method further comprises automatically displaying the social networking information on or through the touch display immediately following the cessation of the touch input. In one embodiment, the method further comprises refreshing the social networking information one or more times with one or more additional touch inputs.

One aspect of the invention is directed to a method executed on a computing device for generating delineated geographic content, the method comprising: i) detecting at the processor on the computing device an initialization of creation of content, initialized by a first input event comprising a click input on a peripheral device associated with the computing device through an application on the computing device, wherein the application is associated with geographical information viewable on or through a display associated with the computing device, and ii) detecting at the processor a finalization of creation of content, finalized by a second input event comprising the cessation of the click input on the touch display, wherein the created content comprises delineated geographic content associated with social networking information.

In one embodiment, the delineated geographical content comprises existing delineated geographic content. In another embodiment, the delineated geographical content comprises crowd sourced delineated geographic content.

Another aspect of the invention is directed to a communication application that displays geographically delineated content based on at least one user generated input comprising an interface configured to display one or more options to an associated user, a delineation module configured to associate user generated content derived from the one or more options to a unique identifier associated with the user, and provide geographically delineated content relating to the unique identifier on the interface.

In one embodiment, the application further comprises a relation module configured to compare the user generated content from a plurality of users. In another embodiment, the application further comprises a relation module configured to compare the geographically delineated content provided to a plurality of users. In one embodiment, the relation module is further configured to rank users based at least in part on the relationship that their geographically delineated content are matched with other users. In another embodiment, the relation module is further configured to rank users based at least in part on the relationship that their user generated content are matched with a other users.

In one embodiment, the interface is displayed on a phone. In another embodiment, the interface is displayed on a computer. In another embodiment, the interface is displayed on a mobile device. In another embodiment, the interface is displayed on a tablet device.

In one embodiment, the relation module is further configured to process and to communicate trending of user generated content and/or trending of geographically delineated content. In one embodiment, the trending is based at least in part on a prior providing of geographically delineated content to the user and/or to a different user. In one embodiment, the application further comprises a module configured to communicate the trending with at least one associated social networking site. In another embodiment, the application further comprises a controller module configured to restrict and allow access to user generated content and/or geographically delineated content.

In one embodiment, the user generated content comprises geographic information about the user. In another embodiment, the user generated content comprises geographic information about another user. In another embodiment, the user generated content comprises geographic information about a location of interest of the user. In another embodiment, the geographically delineated content comprises content obtainable from at least one associated social networking site. In another embodiment, the geographically delineated content comprises content relevant to the user generated content.

Another aspect of the invention is directed to a method of displaying geographically delineated content, comprising the steps of i) displaying on an interface to a user at least one option, ii) receiving from the user a user generated input, iii) delineating a unique identifier from the user generated input comprising geographical information, iv) associating the unique identifier with the user, and v) providing geographically delineated content relating to the unique identifier on the interface.

Another aspect of the invention is directed to a method of generating geographically delineated content, comprising the steps of i) displaying on an interface to a user at least one option comprising a representation of one or more geographic locations, ii) receiving from the user a user generated input, iii) delineating geographically delineated content based on the user generated input, thereby generating geographically delineated content.

Another aspect of the invention is directed to a method of providing a social networking interface comprising i) receiving from a user a user generated input associating the user with a geographic location, and ii) generating geographically delineated content based on the user generated input, wherein the geographically delineated content comprises content from an associated social networking site, thereby providing to the user a social networking interface.

In one embodiment, the method further comprises storing the geographically delineated content. In another embodiment, the method further comprises providing to the social networking site with the geographically delineated content or information related thereto. In one embodiment, the method further comprises providing the geographically delineated content to a second user. In another embodiment, the method further comprises providing the user generated input to a second user. In another embodiment the method further comprises aggregating the geographically delineated content from a plurality of associated social networking sites.

In one embodiment, the method further comprises distributing to one or more users the aggregated geographically delineated content. In one embodiment, the method further comprises receiving from a user information relating to the geographically delineated content. In another embodiment, the method further comprises transmitting to the associated social networking site and/or one or more other users the received information.

Another aspect of the invention is directed to a method executed on a computing device for generating delineated geographic content on a touch display of the computing device, the method comprising i) detecting at a processor on the computing device an initialization of creation of content, initialized by a first input event comprising a touch input on the touch display through an application on the computing device, and ii) detecting at the processor a finalization of creation of content, finalized by a second input event comprising the cessation of the touch input on the touch display, wherein the created content comprises delineated geographic content.

In one embodiment, the computing device generates a visual geographic representation, such that the creation of content contains at least a subset of the visual geographic representation. In one embodiment, the visual geographic representation comprises a street map. In another embodiment, the visual geographic representation comprises a satellite image. In another embodiment, the visual geographic representation comprises a mass transit map. In another embodiment, the visual geographic representation comprises an image of at least one geographic location. In another embodiment, the visual geographic representation comprises a schematic illustration of a detectable activity. In one embodiment, the detectable activity comprises traffic on a web site or mobile application.

In accordance with one embodiment, the first touch input comprises a user touching the touch display. In another embodiment, the touch input comprises a user touching the touch display with a single finger. In another embodiment, the touch input comprises a user contacting the touch display with a compatible article. In one embodiment, the delineated geographic content comprises a two dimensional space.

Another aspect of the invention is directed to a method executed on a computing device for generating delineated geographic content on a touch display of the computing device, the method comprising i) detecting at a processor on the computing device an initialization of creation of content, initialized by a first input event comprising a touch input on the touch display through an application on the computing device, wherein the application is associated with geographical information viewable on or through the touch display, and ii) detecting at the processor a finalization of creation of content, finalized by a second input event comprising the cessation of the touch input on the touch display, wherein the created content comprises delineated geographic content associated with social networking information.

In one embodiment, the method further comprises displaying the social networking information on or through the touch display. In accordance with one embodiment, the method further comprises automatically displaying the social networking information on or through the touch display immediately following the cessation of the touch input. In one embodiment, the method further comprises refreshing the social networking information one or more times with one or more additional touch inputs.

Another aspect of the invention is directed to a method executed on a computing device for generating delineated geographic content, the method comprising: i) detecting at a processor on the computing device an initialization of creation of content, initialized by a first input event comprising a click input on a peripheral device associated with the computing device through an application on the computing device, wherein the application is associated with geographical information viewable on or through a display associated with the computing device, and ii) detecting at the processor a finalization of creation of content, finalized by a second input event comprising the cessation of the click input on the touch display, wherein the created content comprises delineated geographic content associated with social networking information.

In accordance with one embodiment, the delineated geographical content comprises existing delineated geographic content. In accordance with another embodiment, the delineated geographical content comprises crowd sourced delineated geographic content.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 is a block diagram showing an example process for providing geographically delineated content that uses services, as discussed herein;

FIG. 3 is a block diagram showing an example process for amending a user or client received input according to one embodiment of the present invention;

FIG. 4 shows an example computer system with which various aspects of the invention may be practiced;

FIG. 5A shows an example interface in which user or client input may be provided according to one embodiment of the present invention;

FIG. 5B shows an additional example interface in which user or client input may be provided according to one embodiment of the present invention;

FIG. 6 shows an example interface in which geographically delineated content may be displayed according to one embodiment of the present invention; and

FIG. 7 shows an example interface in which a heatmap visualization may be displayed according to one embodiment of the present invention.

### DETAILED DESCRIPTION

Embodiments disclosed herein include services, application systems, applications, and methods for providing geographically delineated content. Geographically delineated content can include social media content or social networking information that is relevant to one or more geographic locations. For example content can include text, photographs, videos, hyperlinks, audio files, and/or generated enrichments. Content can be provided by one or more social media content providers, online repositories of information, or any other provider of location-based relevant content. Although social media content providers as described herein include social media platforms such as Twitter, Facebook, MySpace, LinkedIn, Pinterest, Foursquare, Yelp, Tripadvisor, and Tumblr, in further embodiments, providers can include any social media content provider as is understood in the art (including any media that is produced by a human (user generated content), which may not necessarily be considered social media content or platforms). Content can be generated by any content source such as social media platform users, companies, or any other source of social media content.

In various aspects, geographic location, as used herein, can refer to a country, a state, a city, a neighborhood, a building, a venue, an address, coordinates such as longitude and latitude, or any other information descriptive of a location. Although geographic location as used herein includes a single geographic location, in various embodiments, geographic location can include a plurality or a series of locations. In various embodiments, the geographically delineated content includes an attached (“tagged”) geographic location.

As described above, in some embodiments this can include a “check-in” to particular locations, including venues such as businesses, retail locations, events, points of interest, or other locations. A check-in generally includes a process that identifies the user with a particular location at a given time, and may be recorded over time. In other embodiments, the geographically delineated content is automatically tagged with a geographic location. For example, geographically delineated content generated from a content provider device having a Global Positioning System (“GPS”) may automatically embed location information in the generated content. In further embodiments, a social media platform may allow a user to manually enter location information. While some content providers may not provide a location with generated content, location may still be inferred from intrinsic information, such as metadata (e.g., metrics) associated with the content. It should be appreciated that geographically delineated content should not be limited to content tagged with a geographic location in any particular manner.

### Location-Based Systems and Processes

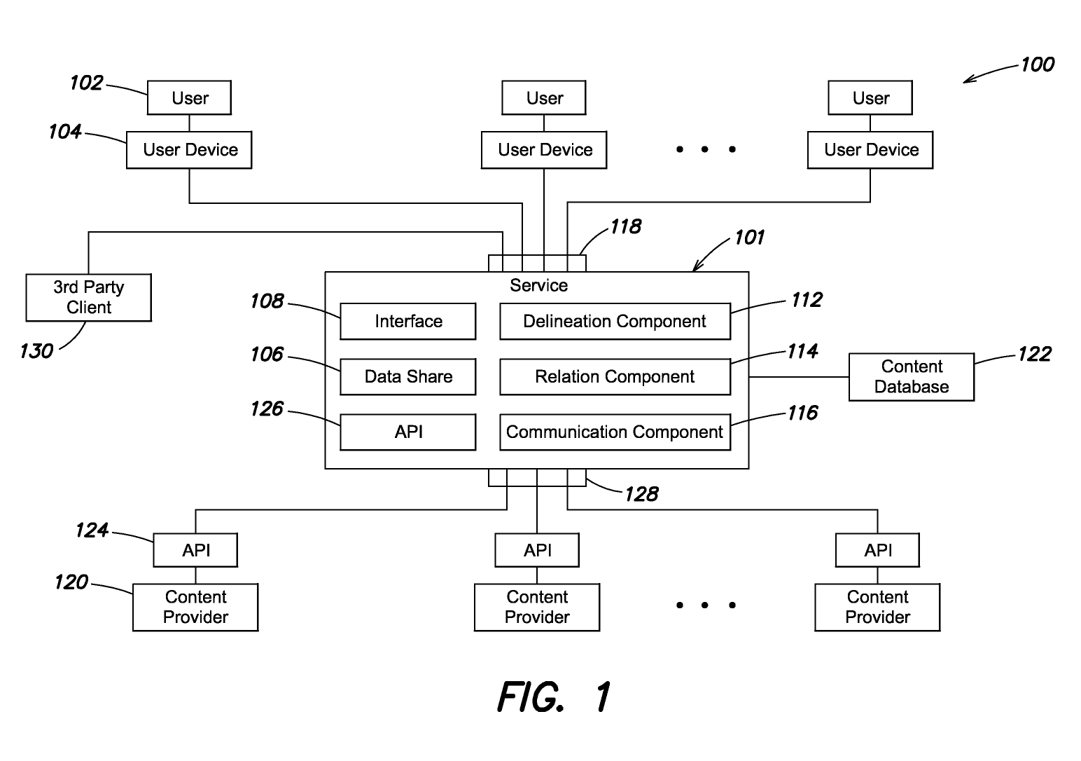

Turning now to FIG. 1, a block diagram of a location-based service and system suitable for incorporation of various aspects of the present invention is shown. For instance, the service 101 may permit one or more users (e.g., user 102) to request and receive geographically delineated content associated with the user's input identifying a geographic location. The entered location may be specified in the request for geographically delineated content. As shown, in one embodiment, the system can include a computing device (e.g., user device 104) having a memory, a user interface, and one or more processors. For example, the user device 104 can include a cell phone, smart phone, PDA, tablet computer, laptop, or other computing system. Users 102 may use the interface of the user device 104 for interacting with the system 100 to receive geographically delineated content. In other embodiments, the service may permit one or more third party client systems (e.g., client 130) to request and receive geographically delineated content associated with a client's input identifying a geographic location.

In one embodiment, the service may include one or more components. Such components may be implemented using one or more computer systems. In one embodiment, service 101 may be implemented on a distributed computer system using one or more communication networks (e.g., the Internet). In one implementation, the service is implemented in a cloud-based computing platform, such as the well-known EC2 platform available commercially from Amazon.com, Seattle, Wash. Other implementations are possible and are within the scope and spirit of the invention, and it is appreciated that other platforms may be used.

Service 101 may include a webserver which is capable of serving as a front end to the location-based service 101. User devices 104 and/or clients 130 may receive and display geographically delineated content aggregated and distributed by service 101. Notably, devices 104 and clients 130 may include controls that perform various functions in an application (e.g., a mobile application). Further, such devices 104 and clients 130 provide an input identifying a geographic location generated by the user 102 or the client. The user, or client, input may be used to perform one or more functions.

Service 101 may also provide one or more related services, such as a service for providing location-based social media content. Services may be integral to service 101 or may alternatively operate in conjunction with service 101 (e.g., by communicating with the service 101 through an Application Programming Interface (API)). In some implementations, the service 101 is configured to execute one or all of a plurality of components including a delineation component 112, a relation component 114, and a communication component 116.

The interface 108 of the service 101 is configured to receive from the user device 104, or the client 130, an input identifying or defining a geographic location. In various embodiments, the input includes a plurality of points, segments, arcs, edges or other delineations. For example, the input can include a polygon defined in a visual geographic representation of a geographic location identified by the user device 104 or client 130. The visual geographic representation can include a street map, a satellite image, a mass transit map, an image of at least one geographic location, or a schematic illustration of a detectable activity.

In an embodiment, the detectable activity comprises traffic on a website or mobile application. In this embodiment, the interface 108 is configured to provide a tool to permit the user or client to define the polygon. Tools can include, but should not be limited to, an expanding radius search, a bounding box search, and a customizable drawing tool, such as a cursor or mouse.

In further embodiments, the interface 108 is further configured to “snap close” or automatically complete an unfinished or incomplete polygon. In further embodiments, the interface 108 can be further configured to permit fine tuning adjustments of the input. For example, once the input is entered, the user or client may refine their input by making slight adjustments by pushing, pulling, or dragging the polygon that defines the geographic location. The user or client may do this by moving individual lines of the polygon, discrete points on the lines of the polygon, or “pushing” or “pulling” boundaries of the polygon.

In one embodiment, the user device 104 includes a touch display in communication with the one or more processors and configured to display a user requested visual geographic representation prior to identification of the geographic location (e.g., a map). For example, the user may request a map of Boston, Mass. prior to defining polygon to request geographically delineated content for. In one embodiment, user device 104 is configured to detect at the one or more processors an initialization of creation of the input, initialized by a first input event comprising a touch input on the touch display and detect at the processor a finalization of creation of the input, finalized by a second input event comprising the cessation of the touch input on the touch display. In an implementation the first touch input can include the user 102 touching the touch display, the user 102 touching the touch display with a single finger, or the user 102 contacting the touch display with a compatible article.

In some embodiments, the user device 104 is also configured to detect at the one or more processors an initialization of creation of a first input, initialized by a first input event comprising a touch input on the touch display, detect at the one or more processors a first finalization of creation of the first input, finalized by a second input event comprising the cessation of the touch input on the touch display, detect at the one or more processors an initialization of creation of a second input, initialized by a third input event comprising a touch input on the touch display, and detect at the one or more processors a second finalization of creation of the second input, finalized by a fourth input event comprising cessation of the touch input on the touch display. The second input can include, for example, an extension or amendment of the first input. In various embodiments, the second input includes a subtraction from the first created input. In some embodiments, the input includes one or, preferably, a plurality of touch points, or “nobs”, that are of greater size than the polygon, making touch input easier for a user. In various embodiments, a touch display includes an input device with an ability to display information, including a touch screen or touch pad, or a video screen that is able to capture movement, or facial or gesture recognition.

Although described herein as configured to provide tools that permit the user 102 to define a polygon on a geographic representation (e.g., map), in further embodiments, the user interface is configured to receive as a user input: a country, a state, a city, a neighborhood, a building, a venue, an address, coordinates such as longitude and latitude, or any other information descriptive of a location. For example, in one implementation the user 102 may enter “Boston, Mass.” to associate the user with the Boston geographic location, and to define the geographic location as the Boston area.

In other embodiments, the input received by the interface 108 further includes one or more query parameters specifying the geographically delineated content requested. Accordingly, the user, or client, can specify the type or topic of geographic delineated content that is aggregated and provided. For example, the interface 108 can be configured to receive an input consisting of “shoe sales in Boston, Mass.” Once the user or client has satisfactorily entered the input, activation of a search indicator prompts the service 101 to aggregate and distribute geographically delineated content within the identified geographic location, omitting all content outside of the identified geographic location.

In some embodiments, the user or client input may be used to generate geographic delineated content. For example, the user device 104 can be configured to: i) detect at the processor on the device 104 an initialization of creation of content, initialized by a first input event comprising a touch input on the touch display through an application on the device 104, wherein the application is associated with geographical information viewable on or through the touch display; and ii) detect at the processor a finalization of creation of content, finalized by a second input event comprising the cessation of the touch input on the touch display, wherein the created content comprises delineated geographic content associated with social networking information. In various embodiments, the user device 104, is further configured to automatically display the social networking information on or through the touch display immediately following the cessation of the touch input and may also refresh the social networking information one or more times with one or more additional touch inputs.

Although described above as including touch displays, in various embodiments, the user device 104 can be configured to perform one or more processes in response to a click input. For example, the user device 104 can be configured to detect at the one or more processors an initialization of creation of the input, initialized by a first click event comprising a click input on a display and detect at the processor a finalization of creation of the input, finalized by a second click input event on the display.

In one embodiment, the service 101 may store information for each particular user or client, including inputs or preference information identifying location or geographically delineated content type. Specifically, after receiving the input at the interface 108, the user or client may activate a save indicator prompting the service 101 to store the entered input or returned geographic delineated content at a data store 106. In various embodiments, the user or client can label or otherwise “name” a polygon or geographic location specified in the input. Stored inputs can be associated with user profiles and recalled from the data store 106. For example, the service 101 can be configured to associate an entered input with a unique identifier associated with the user or client. The service 101, can then be configured to aggregate and distribute geographically delineated content relating to the unique identifier.

It is appreciated that users of the systems, methods, and services described herein may be interested in social media content generated at the same geographic location over periods of time, for example, a user 102, or client, may make the same request for geographically delineated content in the Boston, Mass. area three times a week. Accordingly, the service 101 permits the user 102, or client, to store entered inputs and defined geographic locations for efficiency and convenience purposes.

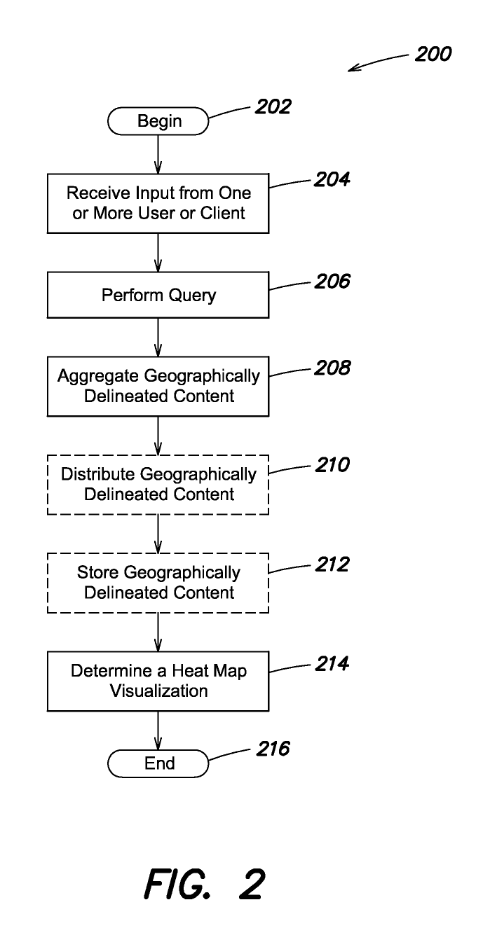

With continuing reference to FIG. 1, FIG. 2 shows an example process (e.g., process 200) for providing geographically delineated content in accordance with one embodiment. At block 202, the process 200 begins. At block 204 an input identifying one or more geographic locations is received from a user or a client, over a network 118. At block 204, a website or application (e.g., application executing on the user device 104) may be displayed to the user 102. Alternatively, an interface such as an API (e.g., API 126) may be provided to an application for providing the input to another application or system, such as the client 130. As discussed above, the input may be provided via one or more interfaces and received at the interface 108 of the service 101. Also, the input may be received from a third party application or system that utilizes location-based services.

At block 206, a component within the service 101 is configured to communicate with at least one content provider 120 through a network connection, e.g., network 128, and/or communicate with a geographically delineated content database, e.g., content database 122 to perform a query. As discussed above, the input received by the interface 108 further can include one or more query parameters specifying the geographically delineated content requested. Accordingly, the user or client can specify the type or topic of geographic delineated content that is aggregated and distributed.

In response to receiving the input, the delineation component 112 generates a query compatible with the one or more content providers 120, including at least the geographic location defined by user or client. For example, the query can be formatted to request geographic delineated content from one or more content provider APIs 124. The APIs 124 associated with one or more content providers 120 permit the exchange of geographic delineated content. However, in other various implementations the delineation component is configured to generate a query for the content provider without using an associated API. It is appreciated that various content provider APIs may have differing limitations and accordingly, in various implementations, the query is formatted specifically for each content provider. In one embodiment, a content provider 120 is queried by specifying a geographic point, for example a longitude and latitude, and designating a radius around that point for aggregating geographically delineated content. Additionally, a time period, or other criteria, may be specified. Requested data is aggregated, received, and stored, for example, in short-term storage. Although described above as performing one query, in various embodiments the delineation component 112 is configured to perform multiple queries in response to receiving a client or user input. For example, the delineation component 112 can be configured to perform a second and a third query to ensure that all areas of the user or client defined geographic location are covered. At block 208, the delineation component 112 is configured to aggregate geographically delineated content from at least one social media content provider (e.g., content provider 120) based on the user or client input. In response to performing the query of block 206, the delineation component 112 receives and aggregates geographically delineated content from the one or more content providers 120. For example, aggregated content can include social media content having an associated geographic location. Content may be aggregated from one or a plurality of content providers 120, as discussed above, in one or a plurality of formats. Content can include text, photographs, videos, and/or audio files, and in additional embodiments, enrichments.

Although described above as configured to query one or more content providers and aggregate geographically delineated content in response to a user or client input, in other embodiments, the delineation component is configured to query one or more content providers and aggregate geographically delineated content automatically. In one embodiment, the delineation component is configured to continually query content providers for content relative to frequently requested geographic locations. For example, the delineation component 112 can be configured to automatically and continually query and aggregate geographically delineated content from Twitter in the Boston, Mass. geographic area. Automatic queries may be time scheduled or random. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

In some embodiments, the delineation component 112 is further configured to delay, postpone, or “put to sleep” automatic queries and aggregations. For example, the delineation component 112 may delay automatic queries and aggregations of geographically delineated content for infrequently requested geographic locations. In this regard, the service 101 can determine whether content requested from a particular location will likely be requested, and delay the query and aggregation if necessary. Delay, postponement, and “put to sleep” configurations permit the service 101 to allocate computing resources. Although discussed herein as performed by a delineation component 112, in various other embodiments, querying one or more content providers 120 and aggregating geographically delineated content may be performed by a plurality of components.

At block 210 (shown in ghost lines as optional), the communication component 116 is configured to distribute the aggregated geographically delineated content to the one or more user devices (e.g., user device 104) or clients (e.g., client 130) permitting the respective user or client to view the geographically delineated content. In further embodiments, the communication component 116 may also distribute user or client generated inputs or geographically delineated content to social networking sites or social media content providers. At block 212 (shown in ghost lines as optional), the service 101 may also be capable storing information in one or more content databases 122. For instance, the service 101 may be configured to store geographically delineated content (e.g., location based social media content) such as text, photographs, videos, and audio files aggregated from at least one content provider 120.

In one implementation, the aggregated content is stored in a geographic quadrant based storage grid. When visualized, the grid resembles a mesh placed over the planet, in which grid lines run parallel to longitude and latitude lines. Accordingly, aggregated geographic content is stored in location-based quadrants related to the tagged location of the content. In other embodiments, aggregated geographic content is stored in a time-based grid, in which aggregated content is stored based on the time the geographic content was generated by the content provider. In other embodiments, aggregated content can be stored in an aggregation-time-based grid, in which aggregated content is stored based on the time the geographic content was aggregated by the delineation component. In further embodiments, the aggregated content can be stored in a subject-based grid, in which aggregated content is stored based on the source or the type of the geographically delineated content (e.g., Twitter, Facebook, MySpace, LinkedIn, Pinterest, or Tumblr content). It should be appreciated that geographically delineated content can be stored in any other fashion as is suitable for geographically delineated content.

Although the communication component 116 as described above in one embodiment is configured to distribute geographically delineated content in response to aggregating content from a content provider 120, in some embodiments, the communication component 116 can be configured to distribute geographically delineated content from the content database 122. In one implementation, the delineation component 112 is configured to query the content database 122 in response to receiving an input from the user device 104 or the client 130.

In an embodiment where the content database 122 includes a geographic quadrant based storage grid, quadrants are accessed relative to the geographic location identified in the input. Quadrants can be accessed at different resolutions, depending on the scope of the user input. Geographically delineated content stored in the content database 122 is aggregated from quadrants that intersect/overlap the geographic location identified in the input. For example, an input identifying Boston, Mass. may overlap example quadrants 1, 2, and 3. Accordingly, the service 101 accesses example quadrants 1, 2, and 3 instead of content in an entire radius of the Boston area, which may inadvertently subsume irrelevant information, such as geographically delineated content from the Cambridge, Mass. area. As such, the service 101 can be configured to provide geographically delineated content from a content database 122 in response to receiving an input identifying a geographic location.

In other embodiments, the content database 122, may or may not include a portion of the geographically delineated content desired by the user 102, or the client. Accordingly, some embodiments include both querying and aggregating geographically delineated content from the content database 122 and the one or more content providers 120. In one implementation, the delineation component is configured to first query and aggregate geographically delineated content from the content database 122. In response to aggregating content from the content database 122, the component is further configured to query and aggregate non-duplicate geographically delineated content from the content providers 120.

At block 214, the relation component 114 may determine a heatmap visualization from the aggregated geographically delineated content. As used herein, one embodiment of a heatmap visualization refers to a volume-based geographically delineated content depiction of the geographic location identified in the input by the user or client. In one implementation, the heatmap visualization includes an image of a geographic location (e.g., a map). For example, the image may include a street map, a satellite image, a mass transit map, or a schematic illustration of a detectable activity.

The heatmap visualization may further include one or more indicators layered over the image of the geographic location. The indicators are configured to show the density of the volume of the geographically delineated content for a discrete spatial area, or a series of spatial areas, on the image and can include but should not be limited to colors, shapes, and images. In one implementation, the heatmap visualization shows a range of colors conveying the volume of social media content in the geographic location to help the user or client understand the geographic layout of social media content or activity. For example, a heatmap visualization for a user or client requested geographic location of Boston, Mass., may show a higher volume of Twitter content in the North End neighborhood than the South End or South Boston neighborhoods.

In some embodiments, the communication component 116 is further configured to distribute the heatmap visualization to the one or more user devices 104 or clients 130. In this regard, the user interface 108 permits interaction with the heatmap visualization. In particular, the interface 108 is configured to permit the display of geographically delineated content in response to selection of one of the plurality of indicators overlayed the image of the geographic location. In other embodiments, the user or client may engage with the heatmap by adjusting one or more filters. For example, filters may include map shape, time period, content source, content type (e.g., text, video, photo, etc.), hashtags, keywords, @mentions, image content (computer vision meta, topics) tagged venues/places, user age, user sex, user topic interest, user domicile, or user influence level. Additionally, in one embodiment, the heatmap visualization is determined in response to aggregating geographically delineated content for an identified geographic location over a period of time. Accordingly, heatmapped historical data permits users and clients to analyze trends and fluctuations in social media content.

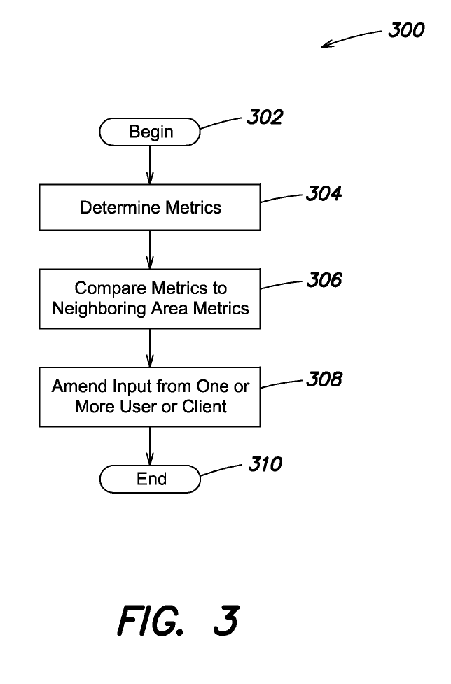

With continuing reference to FIG. 1 and FIG. 2, FIG. 3 shows an example process (e.g., process 300) for amending an input received from the user device 104 or client 130 in response to determining a heatmap visualization. For instance, one or more components of the service 101 may be configured to analyze the determined heatmap visualization and redefine the identified geographic location. Alternatively, one or more components of the service 101 may be configured to analyze the determined heatmap visualization and provide geographic location, social media content, or other heatmap based suggestions to the user or client. In one embodiment, the relation component 114 compares the volume of geographically delineated content in the indicated geographic location to the volume of geographically delineated content in a neighboring area geographically proximate the indicated location. Based on the comparison, the service 101 may automatically expand, shrink, move, or otherwise redefine the indicated geographic location to include or exclude geographically delineated content of the neighboring area.

The process 300 begins at block 302. At block 304, one or more component of the service 101, for example the relation component 114, is configured to determine metrics of the aggregated geographically delineated content. For example, metrics can include but are not limited to geographically delineated content provider, post source volume, content type hashtags, @mentions, geographic location, and computer vision meta data. On top of the metrics, the service 101 is configured to implement machine intelligence including neuro-linguistic programming (“NLP”) or Computer Vision to add enrichments to the aggregated geographically delineated content. In various implementations, enrichments include demographic information, topic detection, scene detection, logo detection, and facial recognition.

At block 306, one or more component, for example the relation component 114, is configured to determine metrics of content in the neighboring area geographically proximate the identified location. The neighboring area may be defined by a user or client entered value, e.g., 500 feet, or, set to a predetermined value. For example, the relation component 114 may begin by determining metrics of a neighboring area twice the size of the identified geographic location. In an embodiment, the relation component further compares the metrics of the indicated geographic location with the metrics of the neighboring area. For example, the relation component 114 can compare metadata to determine similarities and dissimilarities in the geographically delineated content. Similarities and dissimilarities may generate a relevancy score, for example.

In other embodiments, the relation component 114 may further determine trends in the aggregated geographically delineated content based on the determined metrics. In one embodiment, metrics determined from the content of the geographic location and neighboring area over a time period may indicate that a topic or content subject is popular at a particular location at a specific time of year. For example, the metrics determined from geographic delineated content associated with the Symphony Hall venue in Boston, Mass. may show a strong correlation with the topic “Holiday Pops” during the months of November and December. Whereas, metrics determined from the geographic delineated content may show a low correlation during the months of May and June. Accordingly, the relation component can be further configured to automatically redefine, or suggest a redefined input to the user or client, based on determined trends.

In some embodiments, the relation component 114 can be further configured to rank user or clients based, at least in part, on the relationship that their aggregated geographically delineated content are matched with other users. For example, users or clients may be ranked based on similarities or dissimilarities in metrics, geographic location, or identified preferences. Accordingly, the service 101 may additionally tailor aggregated geographically delineated content based on ranked similar users or clients.

At block 308, one or more component, for example the relation component 114, is further configured to amend the input from the user, or the client, in response to the comparison of the content metrics. In response to a “pocket” of similar matched metrics that is outside the bounds of the identified geographic location, the relation component is configured to automatically redefine the geographic location or suggest an amended input to the user or client. Accordingly, automatically redefined, or suggested redefined inputs, provides a user or client with a tailored and more robust aggregation of geographically delineated content. It is appreciated that tailored aggregations of geographically delineated content are efficient from an economic and computing perspective, while remaining informationally robust. The service 101, as described herein, permits a user, or client, to include social media “hotspots” that they may have missed, or that fall outside of their original input.

### Example Computing Device Implementations

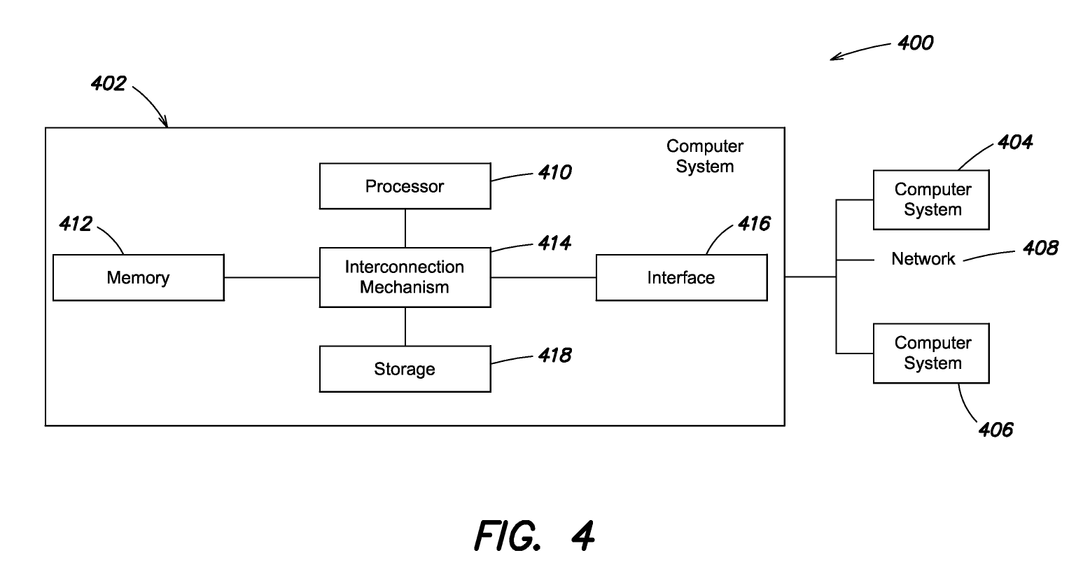

Referring to FIG. 4, there is illustrated a block diagram of a distributed computer system 400, in which various aspects and functions are practiced. As shown, the distributed computer system 400 includes one or more computer systems that exchange information. More specifically, the distributed computer system 400 includes computer systems 402, 404, and 406. As shown, the computer systems 402, 404, and 406 are interconnected by, and may exchange data through, a communication network 408. The network 408 may include any communication network through which computer systems may exchange data. To exchange data using the network 408, the computer systems 402, 404, and 406 and the network 408 may use various methods, protocols and standards, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 402, 404, and 406 may transmit data via the network 408 using a variety of security measures including, for example, SSL or VPN technologies. While the distributed computer system 400 illustrates three networked computer systems, the distributed computer system 400 is not so limited and may include any number of computer systems and computing devices, networked using any medium and communication protocol.

As illustrated in FIG. 4, the computer system 402 includes a processor 410, a memory 412, an interconnection element 414, an interface 416 and data storage element 418. To implement at least some of the aspects, functions, and processes disclosed herein, the processor 410 performs a series of instructions that result in manipulated data. The processor 410 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 410 is connected to other system components, including one or more memory devices 412, by the interconnection element 414.

The memory 412 stores programs (e.g., sequences of instructions coded to be executable by the processor 410) and data during operation of the computer system 402. Thus, the memory 412 may be a relatively high performance, volatile, random access memory such as a dynamic random access memory (“DRAM”) or static memory (“SRAM”). However, the memory 412 may include any device for storing data, such as a disk drive or other nonvolatile storage device. Various examples may organize the memory 412 into particularized and, in some cases, unique structures to perform the functions disclosed herein. These data structures may be sized and organized to store values for particular data and types of data.

Components of the computer system 402 are coupled by an interconnection element such as the interconnection element 414. The interconnection element 414 may include any communication coupling between system components such as one or more physical busses in conformance with specialized or standard computing bus technologies such as IDE, SCSI, PCI and InfiniBand. The interconnection element 414 enables communications, including instructions and data, to be exchanged between system components of the computer system 402.

The computer system 402 also includes one or more interface devices 416 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 402 to exchange information and to communicate with external entities, such as users and other systems.

The data storage element 418 includes a computer readable and writeable nonvolatile, or non-transitory, data storage medium in which instructions are stored that define a program or other object that is executed by the processor 410. The data storage element 418 also may include information that is recorded, on or in, the medium, and that is processed by the processor 410 during execution of the program. More specifically, the information may be stored in one or more data structures specifically configured to conserve storage space or increase data exchange performance.

The instructions may be persistently stored as encoded signals, and the instructions may cause the processor 410 to perform any of the functions described herein. The medium may, for example, be optical disk, magnetic disk or flash memory, among others. In operation, the processor 410 or some other controller causes data to be read from the nonvolatile recording medium into another memory, such as the memory 412, that allows for faster access to the information by the processor 410 than does the storage medium included in the data storage element 418. The memory may be located in the data storage element 418 or in the memory 412, however, the processor 410 manipulates the data within the memory, and then copies the data to the storage medium associated with the data storage element 418 after processing is completed. A variety of components may manage data movement between the storage medium and other memory elements and examples are not limited to particular data management components. Further, examples are not limited to a particular memory system or data storage system.

Although the computer system 402 is shown by way of example as one type of computer system upon which various aspects and functions may be practiced, aspects and functions are not limited to being implemented on the computer system 402 as shown in FIG. 4. Various aspects and functions may be practiced on one or more computers having a different architectures or components than that shown in FIG. 4. For instance, the computer system 402 may include specially programmed, special-purpose hardware, such as an application-specific integrated circuit (“ASIC”) tailored to perform a particular operation disclosed herein. While another example may perform the same operation using a grid of several general-purpose computing devices running MAC OS System X with Intel processors and several specialized computing devices running proprietary hardware and operating systems.

The computer system 402 may be a computer system including an operating system that manages at least a portion of the hardware elements included in the computer system 402. In some examples, a processor or controller, such as the processor 410, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 410 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Example Interfaces

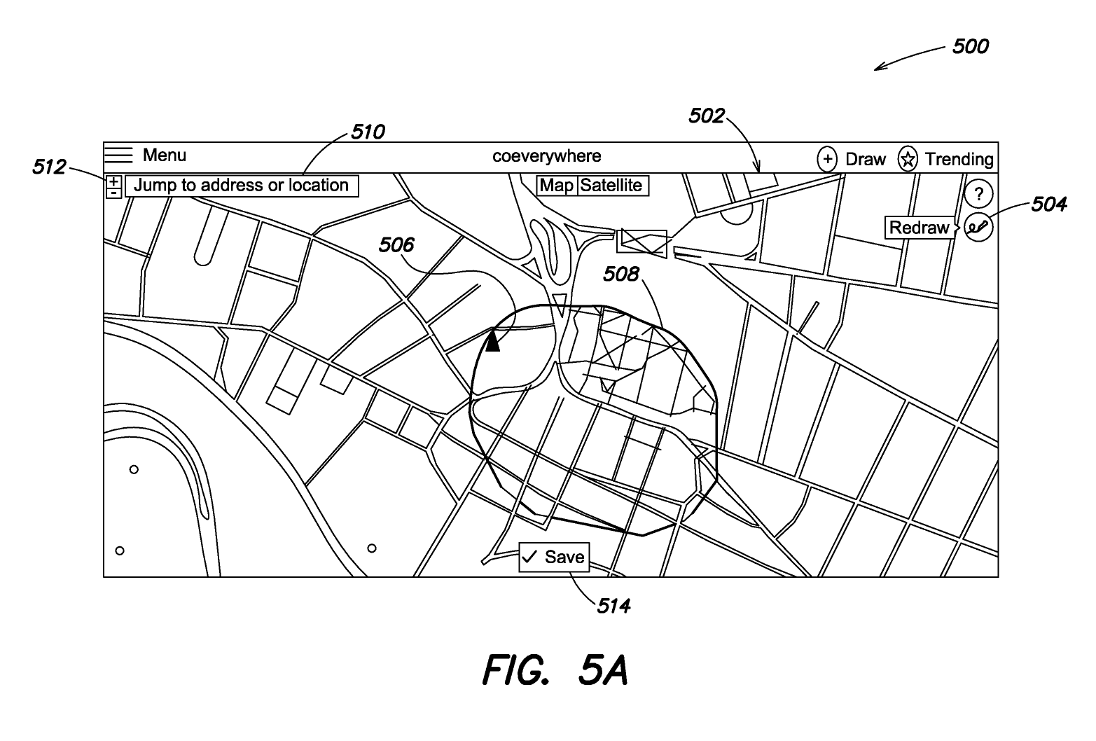

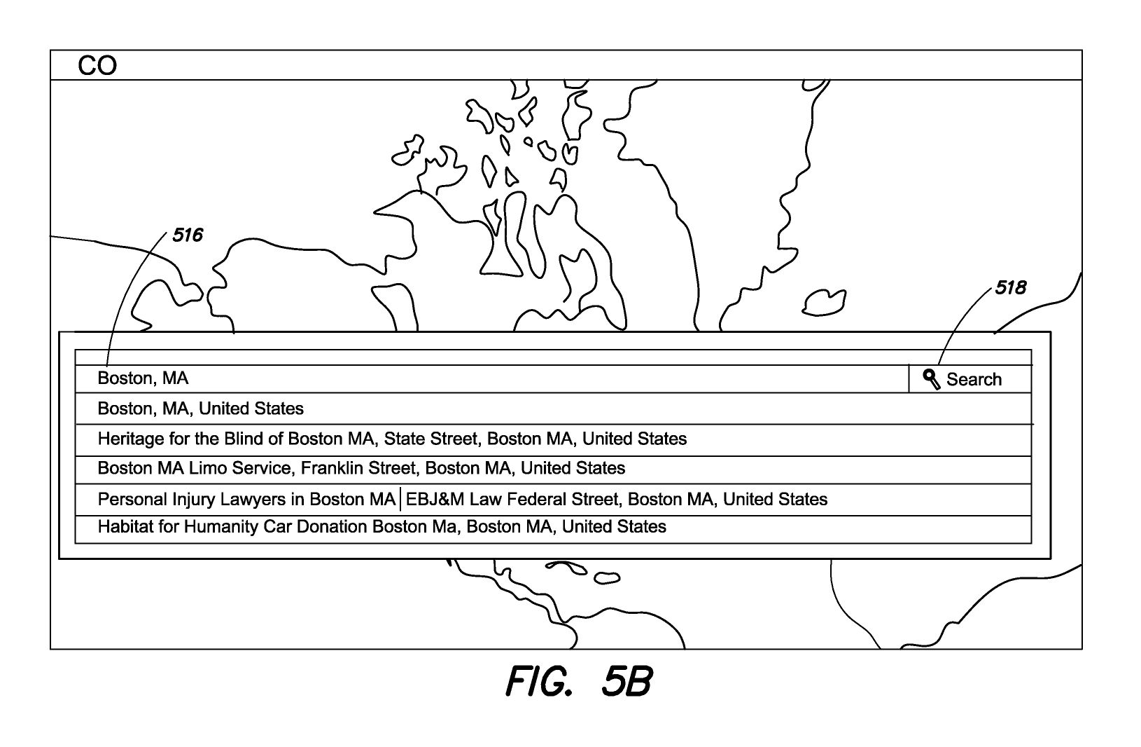

FIG. 5A shows one example interface in which a user or client may enter an input defining a geographic location according to one embodiment. In particular, the interface 500 includes a visual representation of a geographic image (e.g., map 502). In one embodiment, the interface includes a map query 510 permitting the user, or client, to call a desired map or map dimensions. For example, the map query 510 can enable the user to call a map for Boston, Mass., Suffolk County, or the State of Massachusetts. Furthermore, the embodiment can further include a view indicator 512 permitting the user, or client, to zoom-in or zoom-out on the map 502. The interface 500 may also include a drawing tool indicator 504 that provides a drawing tool (e.g., tool 506) permitting the user, or client, to interact with the map 502 to define the bounds of the identified geographic area. In one embodiment, dragging, pulling, or otherwise moving the tool across the map 502 forms a polygon 508 indicating a geographic location. In a further embodiment, the tool 506 additionally permits the user, or client, to reshape, adjust, move, or otherwise redefine the polygon 508. Although not shown, the polygon 506 may also include a series of points permitting the user to drag, push, or pull edges of the polygon shape.

According to one embodiment, the interface 500 may include a search query area where users may enter text based search queries, for example the query parameters discussed above with reference to FIGS. 1-3. FIG. 5B shows an additional exemplary embodiment of an interface having a search query area 516. Furthermore, the interface may include a control, which when activated, queries at least one geographically delineated content provider for geographically delineated content within the indicated geographic location (e.g., polygon 508). For example, the control may include a search indicator 518. Such a search query may be responsive to one or more controls or one or more query inputs to limit the number of aggregated geographically delineated content.

Turning back to FIG. 5A, in one embodiment, the interface 500 may further include save indicator 514 permitting the user, or client, to store the entered input or polygon at a data store. In various embodiments, the user or client can label or otherwise “name” a polygon or geographic location specified in the input. Stored inputs can be associated with user profiles and recalled from the data store.

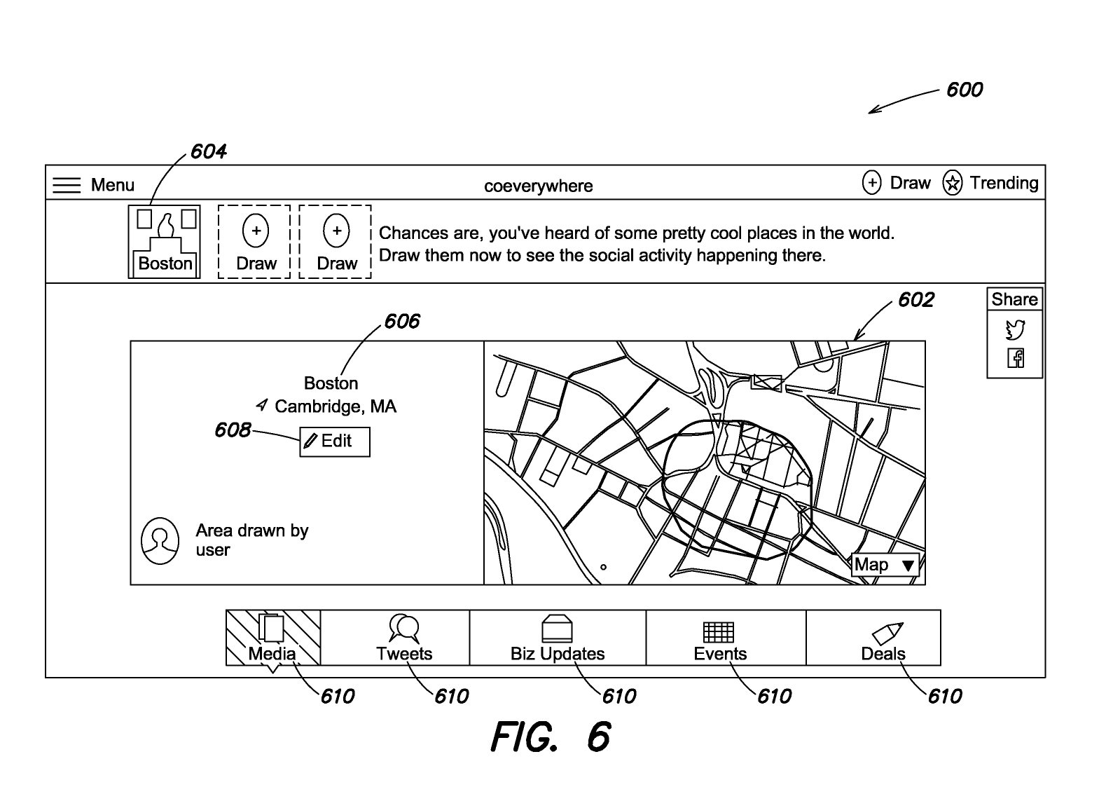

FIG. 6 shows an example interface (e.g., interface 600) for displaying aggregated geographically delineated content according to one embodiment of the present invention. In particular, the interface 600 includes a visual representation of an indicated geographic location (e.g., map 602). As shown, the map 602 can include a map and a polygon, such as map 502 and polygon 508 discussed above with reference to FIG. 5A. In one embodiment, the interface 600 includes a title identifier 606 associated with the map 602. The title identifier 606 can include a name, a place, or any other descriptor generated by the user or client. The interface 600 can additionally include an edit indicator 608 permitting the user or client to edit the title identifier 606. In one embodiment, the interface 600 permits the user or client to alternate between one or more maps. For example, the interface 600 can include one or more visual map indicators 604. Selection of a map indicator expands the selected map for user or client interaction.

In one embodiment, interface 600 may also include one or more content tabs 610 for displaying geographically delineated content in response to the user or client input. As shown in FIG. 6, content tabs can include but should not be limited to media, tweets, business updates, events, and deals. Selection of a content tab 610 displays the aggregated geographically delineated content associated with the indicated geographic location (e.g., polygon). For example, selection of a content tab 610 for “tweets” displays Twitter posts having an associated geographic location falling within the defined polygon. Content tabs 610 permit the user, or client, to filter and/or compartmentalize aggregated geographically delineated content.

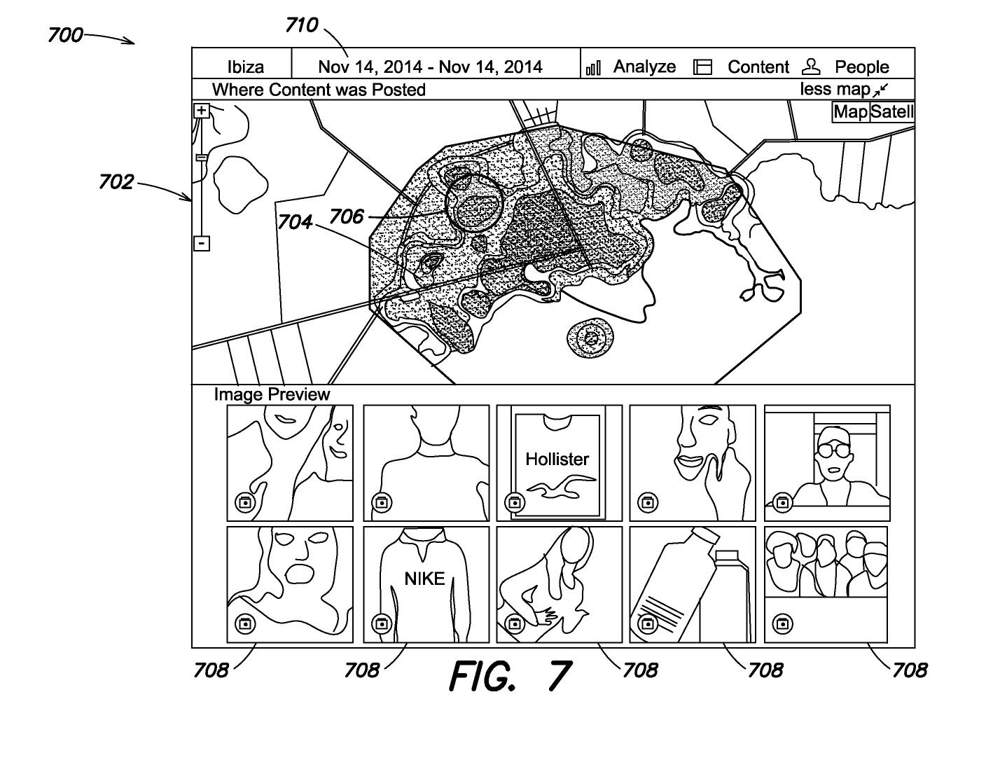

FIG. 7 shows an example interface (e.g., interface 700) for displaying and permitting a user or client to interact with a heatmap visualization, according to one embodiment of the present invention. In particular, the interface 700 includes a heatmap visualization 702 generated in response to aggregated geographically delineated content for an indicated geographic location. As shown, the heatmap 702 can include a map and a polygon, such as map 502 and polygon 508 discussed above with reference to FIG. 5A. The map may additionally include a view indicator permitting the user, or client, to zoom-in or zoom-out on the map, such as view indicator 512, shown in FIG. 5A.

Heatmap 702 also includes one or more indicators 704 layered over the image of the geographic location (e.g., color films). The indicators 704 are configured to show the density of the volume of the geographically delineated content for a discrete spatial area, or a series of spatial areas, on the map and can include but should not be limited to colors, shapes, and images. In one implementation, the heatmap visualization 704 shows a range of colors conveying the volume of social media content in the geographic location to help the user or client understand the geographic layout of social media content or activity.

In one embodiment, the heatmap visualization 702 permits the user, or client, to interact with the geographically delineated content in the associated geographic location. For example, in response to selection of one or more indicators 704 (demonstrated generally by selection circle 706), the interface 700 is configured to display the geographically delineated content 708 associated with the underlying geographic location. As shown in interface 700, geographically delineated content can include any type of social media content. For example, geographically delineated content 708 shown in FIG. 7 includes photos and text. In various embodiments, interface 700 can show the date, or time, of creation of the geographically delineated content.

In further embodiments, the interface 700 further includes a timeline indicator 710 permitting the user, or client, to define a time period from which the interface 700 will display geographically delineated content. For example, FIG. 7 shows a time period ranging from Nov. 14, 2014, to Nov. 21, 2014. Although not shown, in additional embodiments, the interface 700 can further include one or more filter indicators permitting the user to filter geographically delineated content associated with the defined geographic location in the heatmap 702. For example, user, or client, activation of a filter including geographic location shape, time period, content source, content type, hashtags, keywords, @mentions, venue, user age, user sex, use topic interest, user domicile, or user influence level, permits the user, or client, to further refine or tailor the aggregated content.

Accordingly, embodiments disclosed herein include services, application systems, applications, and methods for providing geographically delineated content. Geographically delineated content can include social media content that is relevant to one or more geographic locations. For example content can include text, photographs, videos, and/or audio files. Content can be provided by one or more social media content providers, online repositories of information, or any other provider of location-based relevant content. Although social media content providers as described herein include social media platforms such as Twitter, Facebook, MySpace, LinkedIn, Pinterest and Tumblr, in further embodiments, providers can include any social media content provider as is understood in the art.

What is claimed is:

1. A computer system comprising:
an interface configured to receive, from a user device, a user input identifying a geographic location;
a location-based service including a distributed computer system having at least one processor in data communication with the interface;
a delineation component executable by the at least one processor and configured to query at least one social media content provider and aggregate geographically delineated content generated by one or more user, the content being received from the at least one social media content provider responsive to the received user input; and
a relation component executable by the at least one processor and configured to determine a heatmap visualization from the aggregated geographically delineated content.

2. The system according to claim 1, wherein the heatmap visualization is defined by a volume of the geographically delineated content.

3. The system according to claim 1, wherein the user input further includes one or more query parameters.

4. The system according to claim 1, wherein the geographically delineated content includes at least social media content.

5. The system according to claim 1, further comprising a communication component configured distribute to one or more user devices the aggregated geographically delineated content.

6. The system according to claim 5, wherein the heatmap visualization includes an image of the geographic location and a neighboring area geographically proximate the geographic location.

7. The system according to claim 6, wherein the image includes at least one of, a street map, a satellite image, a mass transit map, and a schematic illustration of a detectable activity.

8. The system according to claim 7, wherein the user device further includes a device interface configured to display the heatmap visualization.

9. The system according to claim 8, wherein the heatmap visualization includes a plurality of indicators disposed on the image, wherein the plurality of indicators indicate the volume of the geographically delineated content.

10. The system according to claim 9, wherein the device interface is further configured to display the geographically delineated content in response to activation of one of the plurality of indicators disposed on the image.

11. The system according to claim 1, wherein the relation component is further configured to automatically amend the user input responsive to at least the heatmap visualization.

12. The system according to claim 11, wherein the relation component is further configured to:
determine metrics of the aggregated geographically delineated content;
compare the metrics of the geographically delineated content to metrics of geographically delineated content of the neighboring area geographically proximate the geographic location; and
amend the user input responsive to the comparison.

13. The system according to claim 12, wherein the metrics include at least one of geographically delineated content provider, post source volume, content type, hashtags, @mentions, geographic location, and computer vision meta data.

14. The system according to claim 11, wherein the relation component is further configured to:
determine a trend in the aggregated geographically delineated content;
compare the trend to the geographically delineated content of the neighboring area geographically proximate the geographic location; and
amend the user input responsive to the comparison.

15. The system according to claim 1, further comprising a content database configured to store the aggregated geographically delineated content.

16. The system according to claim 1, wherein the relation component is further configured to filter the aggregated geographically delineated content responsive to activation of a filter.

17. The system according to claim 14, wherein the filter includes one of geographic location shape, time period, content source, content type, hashtags, image content computer vision topic, keywords, @mentions, venue, user age, user sex, use topic interest, user domicile, and user influence level.

18. A computer system comprising:
an interface configured to receive, from a client, an input identifying a geographic location;
a location-based service including a distributed computer system having at least one processor in data communication with the interface;
a delineation component executable by the at least one processor and configured to query at least one social media content provider and aggregate geographically delineated content generated by one or more user, the content being received from the at least one social media content provider responsive to the received input; and
a relation component executable by the at least one processor and configured to determine a heatmap visualization from the aggregated geographically delineated content.

19. The system according to claim 18, wherein the heatmap visualization is defined by a volume of the geographically delineated content.

20. The system according to claim 18, wherein the input further includes one or more query parameters.

21. The system according to claim 18, wherein the geographically delineated content includes at least social media content.

22. The system according to claim 18, further comprising a communication component configured distribute to one or more clients the aggregated geographically delineated content.

23. The system according to claim 22, wherein the heatmap visualization includes an image of the geographic location and a neighboring area geographically proximate the geographic location.

24. The system according to claim 23, wherein the image includes at least one of, a street map, a satellite image, a mass transit map, and a schematic illustration of a detectable activity.

25. The system according to claim 24, wherein the heatmap visualization includes a plurality of indicators disposed on the image, wherein the plurality of indicators indicate the volume of the geographically delineated content.

26. The system according to claim 18, wherein the relation component is further configured to automatically amend the input responsive to at least the heatmap visualization.

27. The system according to claim 26, wherein the relation component is further configured to:
determine metrics of the aggregated geographically delineated content;
compare the metrics of the geographically delineated content to metrics of geographically delineated content of the neighboring area geographically proximate the geographic location; and
amend the input responsive to the comparison.

28. The system according to claim 27, wherein the metrics include at least one of geographically delineated content provider, post source volume, content type, hashtags, @mentions, geographic location, and computer vision meta data.

29. The system according to claim 26, wherein the relation component is further configured to:
determine a trend in the aggregated geographically delineated content;
compare the trend to the geographically delineated content of the neighboring area geographically proximate the geographic location; and
amend the input responsive to the comparison.

30. The system according to claim 18, further comprising a content database configured to store the aggregated geographically delineated content.

31. The system according to claim 18, wherein the relation component is further configured to filter the aggregated geographically delineated content responsive to activation of a filter.

32. The system according to claim 18, wherein the filter includes one of geographic location shape, time period, content source, content type, hashtags, keywords, @mentions, venue, user age, user sex, use topic interest, user domicile, and user influence level.

33. A computer-executed method comprising acts of:
receiving an input identifying a geographic location;
querying at least one social media content provider responsive to the received input;
aggregating geographically delineated content from the at least one social media provider, the geographically delineated content being received from the at least one social media content provider; and
determining a heatmap visualization from the aggregated geographically delineated content.

34. The method according to claim 33, wherein receiving an input identifying a geographic location further comprises receiving an input from one or more user devices.

35. The method according to claim 33, wherein receiving an input identifying a geographic location further comprises receiving an input from one or more client devices.

36. The method according to claim 33, further comprising an act of defining the heatmap visualization by a volume of the geographically delineated content.

37. The method according to claim 33, wherein receiving an input further includes an act of receiving query parameters.

38. The method according to claim 33, further comprising an act of distributing the aggregated geographically delineated content.

39. The method according to claim 38, further comprising an act of displaying the heatmap visualization, wherein the heatmap visualization includes an image of the geographic location and a neighboring area geographically proximate the geographic location.

40. The method according to claim 39, wherein the act of displaying the heatmap visualization includes an act of displaying at least one of, a street map, a satellite image, a mass transit map, and a schematic illustration of a detectable activity.

41. The method according to claim 39, wherein the act of displaying the heatmap visualization includes an act of displaying a plurality of indicators disposed on the image, wherein the plurality of indicators indicate the volume of the geographically delineated content.

42. The method according to claim 41, further comprising an act of displaying the geographically delineated content in response to activation of one of the plurality of indicators disposed on the image of the geographic location.

43. The method according to claim 33, further comprising an act of automatically amending the input responsive to at least determining the heatmap visualization.

44. The method according to claim 43, wherein amending the input includes acts of:
determining metrics of the aggregated geographically delineated content;
comparing the metrics of the geographically delineated content to metrics of geographically delineated content of the neighboring area geographically proximate the geographic location; and
amending the input responsive to the comparison.

45. The method according to claim 44, wherein the act of determining metrics of the aggregated geographically delineated content includes an act of determining at least one of geographically delineated content source, post source volume, content type, hashtags, @mentions, geographic location, and computer vision meta data.

46. The method according to claim 43, wherein amending the input further includes acts of:
determining a trend in the geographically delineated content;
comparing the trend to the geographically delineated content of the neighboring area geographically proximate the geographic location associated with the user input; and
amending the input based on the comparison.

47. The method according to claim 33, further comprising an act of storing the geographically delineated content.

48. The method according to claim 48, further comprising an act of filtering the aggregated geographically delineated content.

49-115. (canceled)
